(19) United States
(12) Patent Application Publication
(10) Pub. No.: US 2026/0356003 A1
(43) Pub. Date: Nov. 12, 2026

(54) METHOD FOR PRODUCING AN ORIENTED STRAND BOARD AND ORIENTED STRAND BOARD PRODUCTION DEVICE

(71) Applicant: SWISS KRONO Tec AG, Luzern (CH)

(72) Inventors: Georg Seidack, Wittstock/Dosse (DE); Joachim Hasch, Berlin (DE); Norbert Kalwa, Horn-Bad Meinberg (DE)

(21) Appl. No.: 19/121,644

(22) PCT Filed: Nov. 7, 2023
(86) PCT No.: PCT/EP2023/080942

§ 371 Date: Apr. 16, 2025

(30) Foreign Application Priority Data
Nov. 9, 2022 (EP) 22206413.1

(51) Int. Cl. B27N 7/00; B27N 3/24

(52) U.S. Cl. CPC B27N 7/005; B27N 3/24

(57) ABSTRACT

The disclosure relates to a method for producing an oriented strand board including the steps: treating or producing a raw oriented strand board that includes a first lateral surface, a second lateral surface that extends parallel to the first lateral surface, and edge surfaces that connect the lateral surfaces to each other, applying a liquid, which contains paraffin and/or wax, to at least the first lateral surface, including the steps of applying a negative pressure to the second lateral surface so that the liquid is sucked into an edge zone of the raw oriented strand board and/or applying an overpressure to the first lateral surface so that the liquid is pressed into an edge zone of the raw oriented strand board, and heating the first lateral surface.

### FIELD OF INVENTION

The invention relates to a method for producing an oriented strand board according to the preamble of claim 1.

According to a second aspect, the invention relates to an oriented strand board production device with (a) a liquid application device for applying a liquid to the raw oriented strand board, (b) a liquid source that is connected to the liquid application device and contains the liquid, and (c) a suction device that is configured to apply a negative pressure to a main surface of the raw oriented strand board and to automatically apply the negative pressure for such a suction time that the liquid is sucked into an subsurface of the oriented strand board, and/or a pressure application device for applying an overpressure to the first main surface, so that the liquid is pressed into an subsurface of the oriented strand board. The invention also relates to an oriented strand board.

### BACKGROUND OF INVENTION

Oriented strand boards, also known as OSBs, are wood-based material panels made of long, narrow chips that have increased mechanical strength compared to other wood-based material panels. The disadvantage of oriented strand boards is that it is difficult to coat and/or finish their surfaces. Furthermore, oriented strand boards outgas more than other wood-based material panels, as they are made from softwoods with a high resin content. In addition, oriented strand boards are usually sensitive to water as it quickly penetrates the surface of the oriented strand board and may cause chips to swell or become detached.

US 2007/122644 A1 discloses a method for introducing a wax into an OSB panel, in which the wax is dissolved in a solvent and applied to the fiber cake made from oriented, scattered strands. The fiber cake is subsequently pressed to create a wood-based material panel.

EP 3 127 670 A2 describes a method by means of which an impregnation agent in the form of an emulsion is applied to a pressed wood-based material panel by means of multiple nozzles. The nozzles can be individually controlled, so that the application quantity can be adjusted in a spatially resolved manner.

### SUMMARY OF INVENTION

The invention aims to render it possible to produce the oriented strand boards with improved properties.

The invention solves the problem by way of a method for producing an oriented strand board according to the preamble comprising the steps (c) applying a negative pressure to the second main surface, so that the liquid is sucked into an subsurface of the raw oriented strand board and/or applying an overpressure to the first main surface, so that the liquid is pressed into the raw oriented strand board, and where applicable (d) heating the first main surface so that the paraffin and/or the wax melts and penetrates the surface of the oriented strand board.

According to a second aspect, the invention solves the problem by way of an oriented chip board production device according to the preamble in which the liquid contains paraffin and/or wax. It is beneficial if the oriented strand panel production device comprises a heating device arranged downstream of the liquid application device in the direction of material flow, said heating device being configured and arranged to automatically heat a first main surface, which lies opposite the second main surface, to a temperature at which the paraffin and/or the wax melts and does not decompose.

In addition, the invention relates to an oriented strand board production device comprising a press for pressing at least one primary product layer to form a raw oriented strand board and an oriented strand board coating device according to the invention. The liquid application device is suitable, in particular arranged, for applying a liquid to the raw oriented strand board. When the oriented strand board production device is referred to in the following, it generally also refers to the oriented strand board coating device.

The advantage of the invention is that an oriented strand board with an increased resistance to water can be produced without having to use organic solvents and/or crosslinking substances.

In addition, chips can usually be prevented from detaching when the oriented strand board comes into contact with water. This increases the scope of use of oriented strand boards.

In the context of the present invention, paraffin refers to a mix of acyclic alkanes. Paraffin is inert and non-poisonous, which is advantageous.

Wax refers to a mix of hydrocarbons that melt above 40 °C without decomposing and then form a low-viscosity liquid. Waxes are understood to mean both natural waxes and industrially manufactured waxes. This includes animal waxes, vegetable waxes, mineral waxes, petroleum waxes, and synthetic waxes. Waxes are kneadable, especially at 20 °C, solid to brittle hard, coarse to fine crystalline, translucent to opaque, but not glassy. Preferably, the wax is selected in such a way that it is not brittle at 20 °C.

The feature that the liquid contains paraffin and/or wax is understood particularly to mean that the liquid contains standard paraffin, intermediates, micro waxes, paraffin wax and/or a mix thereof. The liquid is preferably water-based and contains an emulsifier.

The feature that the first main surface is heated so that the paraffin and/or the wax melts is understood particularly to mean that the temperature of the main surface is heated to such a degree, for example by infrared radiators or by means of warm air, that the paraffin and/or the wax at least partially melts and, at least in sections, forms a film.

The liquid preferably contains an inorganic solvent. For example, the solvent is hydrophilic, particularly water-based. The liquid is preferably a dispersion or an emulsion.

Preferably, the negative pressure is applied in such a way that the pressure acting on the main surface is at most 300 hPa, in particular at most 200 hPa.

Preferably, the overpressure is applied in such a way that the pressure acting on the main surface is at least 300 hPa, in particular at most 200 hPa.

If both a negative pressure and an overpressure are applied, the pressure difference between the two main surfaces is preferably at least 1000 hPa.

The oriented strand board preferably has a length of 2800 to 5600 mm and/or a width of 2000±100 mm.

The liquid is preferably not crosslinking. To achieve crosslinking, it is usually necessary to use organic solvents, which is not desirable and may cause environmental damage. By melting the paraffin and/or the wax, a paraffin and/or wax layer forms without the need for an organic solvent.

According to one preferred embodiment, the liquid is applied in such an application quantity that the oriented strand board has an oriented strand board water vapor permeability which is at least 30%, especially at least 40%, smaller than a raw oriented strand board water vapor permeability of the raw oriented strand board. To achieve this requirement, the application quantity and/or the concentration of paraffin and/or wax in the liquid can be successively increased until the specified criterion is met.

The water vapor permeability is preferably measured according to DIN 53122-1. Phosphorus pentoxide can be used as a desiccant. A test container filled with desiccant is sealed by a circular sample with a diameter of 9 cm. The sample extends horizontally. A 5 ml drop of water is dropped onto the center of the oriented strand board and the increase in water in the test container due to the water permeating through the sample is determined by weighing. The edge of the oriented strand board can be sealed against penetrating moisture using silicone. The measurement is carried out on three independent samples.

If the oriented strand board is only coated with paraffin and/or wax on one side, in line with one preferred embodiment, the coated side faces away from the test container.

The oriented strand board water vapor permeability is preferably at most 20 grams of water per square meter and per day.

According to one preferred embodiment, the liquid contains solid particles, for example of a hard material. Preferably, the hard material has a hardness of at least 530 HV 10, in particular at least 790 HV 10, in particular at least 1100 HV 10, in particular at least 1400 HV 10, in particular at least 1900 HV 10.

It is possible, but not essential, for the oriented strand board production device to comprise a heating device configured and arranged to melt the paraffin and/or the wax.

The grain size is preferably between F120 and F80 (FEPA standard) and/or 70-100 μm when measured as mesh size.

It is favorable if between 30 grams per square meter and 100 grams per square meter of solid particles are applied. It has been shown that this leads to a sufficiently large increase in slip resistance. The slip resistance is a measure of the coefficient of friction. For example, the slip resistance is measured as an angle of inclination at which a steel cuboid with a contact surface, with which the steel cuboid rests on the main surface, of 40 cm×10 cm and a mass of 500 g begins to slip.

The liquid preferably contains elemental carbon, in particular carbon black and/or graphite.

It is then also possible, but not essential, for the oriented strand board production device to comprise a heating device configured and arranged to melt the paraffin and/or the wax. Known oriented strand boards have a comparatively low absorption capacity for infrared radiation. By applying the liquid with elemental carbon, the absorption capacity for infrared radiation is significantly increased in a simple way.

Preferably, a concentration of elemental carbon in the liquid and an application quantity of liquid are selected such that an oriented strand board reflectivity of the oriented strand board in the direction of a normal to the main surface of the oriented strand board to which the liquid has been applied is at least 0.05, in particular at least 0.075, particularly preferably at least 0.1, in particular at least 0.15, less than a raw oriented strand board reflectivity of the raw oriented strand board at 23 °C under light with a wavelength of 350 nm. The greater the concentration of elemental carbon and the application quantity, the greater the difference between the emission degrees of the raw oriented strand board and the oriented strand board. The reflectivity is determined by irradiating light of the specified wavelength, measuring the intensity of the reflected light of the same wavelength and forming the quotient of irradiated light intensity and reflected light intensity.

Known oriented strand boards also have the disadvantage that they become easily electrostatically charged at low relative humidity. In addition, they have low residual moisture after production, which enhances this effect. According to one preferred embodiment, the liquid contains a salt. As a result, the conductivity of the oriented strand boards increases in its subsurface. Preferably, a concentration of the at least one salt in the liquid and an application quantity of the liquid to the raw oriented strand board are selected such that an electrical oriented strand board conductivity of the oriented strand board is at least 50%, in particular at least 100%, greater than an electrical raw oriented strand board conductivity of the raw oriented strand board. The conductivity increases with the concentration of the salt in the liquid and the application quantity. By successively increasing one or both variables, the concentration and application quantity can be determined that results in oriented strand boards with the specified property.

Preferably, the concentration and the application quantity are selected in such a way that the oriented strand board conductivity is at least five times, and ultimately at least ten times, as high as the raw oriented strand board conductivity. The conductivity is measured by pressing two copper electrodes with a round contact surface with a diameter of 1 cm with a force of 10 Newton in the normal direction onto the main surface onto which the liquid has been applied. Measurements are carried out at five different locations on the oriented strand board and the arithmetic mean calculated.

It is beneficial if the liquid contains a dye. This allows the oriented strand board to be colored with little effort.

The liquid is preferably applied by means of nozzles and/or rollers, for example from above or from below.

In addition, it is possible that the liquid is applied to the main surface from below. During application, the liquid preferably comes into contact with the main surface with its at least essentially horizontal liquid surface.

According to one preferred embodiment, the overpressure is built up by means of the liquid. This is especially advantageous if the liquid is applied to the main surface from below. However, it is often advantageous to apply the liquid from above in order to detect any errors during application of the liquid more easily.

Preferably, the method comprises the steps of (a) pressing an applicator of the pressure application device against the raw oriented strand board so that an introduction chamber is formed between the applicator and the raw oriented strand board, which is sealed by a seal of the applicator, (b) injecting liquid into the introduction chamber and (c) then reducing an introduction pressure in the introduction chamber, in particular to ambient pressure. The applicator is pressed against the raw oriented strand board from below or from above. This allows process-safe liquid to be introduced into the raw oriented strand board.

The method preferably comprises the steps (a) moving the applicator relative to the raw oriented strand board after reducing an introduction pressure, (b) re-pressing the applicator against the raw oriented strand board, (c) injecting liquid into the introduction chamber, (d) reducing an introduction pressure (pe) in the introduction chamber, in particular to ambient pressure, and (e) repeating the aforementioned steps until the raw oriented strand board is provided with the liquid.

Preferably, the negative pressure is applied to a suction surface by means of a suction hood. It is favorable if the suction surface corresponds to a pressure surface where the liquid is injected. The suction surface is the part of the corresponding main surface where the negative pressure (compared to the ambient pressure) is applied. Accordingly, the pressure surface is the surface of the (opposite) main surface where the pressure (compared to the ambient pressure) is applied. The feature that the suction surface corresponds to the pressure surface is understood in particular to mean that the projection of the suction surface onto the plane in which the pressure surface extends forms an intersection with the pressure surface, the area of which corresponds to at least 0.75 times, in particular 0.8 times, preferably 0.85 times, particularly preferably 0.95 times, the area of the pressure surface.

The applicator is preferably moved at least temporarily relative to the raw oriented strand board when the liquid is injected. Alternatively or additionally, the oriented strand board is moved at least temporarily and the applicator is moved with it. This means that the liquid can be applied at a locally increased concentration.

Alternatively, a concentration of paraffin and/or wax and the application quantity as well as the negative pressure and the suction time are selected such that an internal concentration of paraffin and/or wax in an inner thickness quintile of a thickness expansion from the first main surface to the second main surface is at most 0.8-times, in particular at most 0.6 times, preferably at most 0.4 times, particularly preferably at most 0.1 times, an outer concentration in an outermost thickness quintile extending to the first main surface. This results in a particularly high water-repellent effect without having to add a lot of paraffin and/or wax.

The liquid is preferably applied in such a way that the subsurface of at least 90% of a main surface area of the oriented strand board contains paraffin and/or wax. The areas containing an insufficient amount of paraffin and/or wax usually have to be removed. Applying the liquid to at least 90% of the corresponding main surface reduces waste.

The application of the liquid comprises or is, for example, spraying, applying, pouring and/or flooding.

According to one preferred embodiment, the application quantity is selected in such a way that 75 g/m², particularly at least 85 g/m², particularly preferably at least 90 m/g², of paraffin and/or wax is applied to the main surface. It has been proven that this can achieve an effective reduction in the water vapor permeability.

Preferably, a concentration of wax and/or paraffin in the liquid corresponds to at least 25 percent by weight, in particular at least 30 percent by weight, particularly preferably at least 35 percent by weight, especially at least 40 percent by weight. In this way, little solvent, in particular water, is introduced into the raw oriented strand board, which facilitates subsequent drying, which is optional.

Preferably, the liquid contains a dye. This dye is preferably not elemental carbon.

Preferably, a temperature of the liquid during application to the main surface is below a melting temperature of the paraffin and/or the wax. This prevents large paraffin and/or wax particles from forming prematurely.

It is beneficial if the first main surface is heated to a temperature of at least 50 °C. This means that the paraffin melts sufficiently quickly.

According to one preferred embodiment, the method comprises the steps of (a) rotating the raw oriented strand panel after the liquid has been sucked into the subsurface of the first main surface, (b) applying the liquid to the second main surface and (c) applying a negative pressure to the first main surface so that the liquid is sucked into the subsurface of the second main surface of the raw oriented strand panel, resulting in the oriented strand panel.

According to one preferred embodiment, the suction device is configured to automatically apply the negative pressure for such a suction time that the liquid is not sucked through the raw oriented strand board. Alternatively or additionally, the pressure application device is configured to automatically apply the overpressure for such an overpressure time that the liquid is not pressed through the raw oriented strand board.

The pressure application device is preferably designed to apply the overpressure to a pressure surface that corresponds to at least 50%, preferably at least 80%, particularly preferably at least 90%, of an area of the oriented strand board. This allows liquid to be introduced quickly into the raw oriented strand board.

According to one preferred embodiment, the oriented strand board production device has (a) an applicator which is designed to press against the raw oriented strand board so that an introduction chamber is formed between the applicator and the raw oriented strand board, said chamber being sealed by a seal of the applicator, and (b) a control unit which is designed to automatically carry out a process comprising the steps of controlling the applicator (i) so that it presses liquid into the introduction chamber and (ii) then reduces an introduction pressure in the introduction chamber, in particular to ambient pressure.

The applicator preferably has an actuator for pressing the applicator against the raw oriented strand board.

The suction device is preferably arranged to apply a negative pressure to a suction surface that corresponds to the pressure surface.

The invention also includes an oriented strand board which has an inner concentration of paraffin and/or wax in an inner thickness quintile of a thickness extension from the first main surface to the second main surface which corresponds at most to 0.5 times, in particular at most to 0.25 times, particularly preferably at most to 0.1 times, an outer concentration in a first outermost thickness quintile which extends to the first main surface.

Alternatively or additionally, a second decile concentration of paraffin and/or wax in the second thickness decile of the thickness expansion, which lies in the direction of a center of the thickness expansion next to the first, outermost thickness decile (D1), is at most 0.5 times, in particular at most 0.25 times, so preferably at most 0.1 times, the outer concentration. Such an oriented strand board has a low water vapor permeability with a comparatively low paraffin and/or wax content.

Preferably, elemental carbon, in particular carbon black or graphite, is applied to at least 50% of the main surface.

Alternatively or additionally, the oriented strand board preferably has at least 30 g per square metre of hard material particles which have a grain size of between 70 and 150 μm, the hard material particles being bound to coarse chips by paraffin and/or wax.

Again, alternatively or additionally, an area-specific application quantity of elemental carbon is at least 10 g/m² and/or at most 100 g/m².

A thickness of the oriented strand board is preferably between 8 and 35 mm.

### BRIEF DESCRIPTION OF DRAWINGS

In the following, the invention will be explained in more detail with the aid of the accompanying drawings. They show:

FIG. 1 shows an oriented strand board coating device according to the invention as part of an oriented strand board production device according to the invention for carrying out a method according to the invention for an oriented strand board according to the invention;

FIG. 2 shows a detailed view of the oriented strand board production device according to FIG. 1;

FIG. 3a shows a schematic cross-section through an oriented strand board according to the invention;

FIG. 3b shows the inner concentration of paraffin and/or wax of an oriented strand board according to the invention in accordance with a first embodiment, and

FIG. 3c shows the inner concentration of paraffin and/or wax according to a second embodiment; and

FIG. 4 shows a detail view of an oriented strand board production device according to a second embodiment with a suction device and a pressure application device;

FIG. 5 shows a schematic detail view of an oriented strand board production device that comprises an applicator; and

FIG. 6a shows a schematic side view of an oriented strand board production device according to the invention with a movable applicator and a movable suction hood,

FIG. 6b shows the oriented strand board production device according to partial FIG. 6a in a view from above, and

FIG. 6c shows a schematic side view of an oriented strand board production device according to the invention with a movable applicator according to a second embodiment.

### DETAILED DESCRIPTION

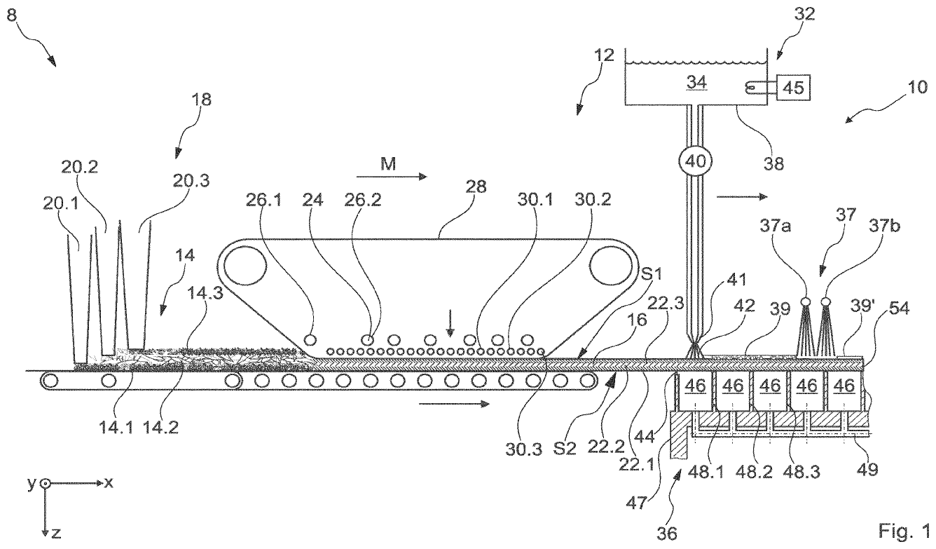

FIG. 1 schematically depicts an oriented strand board production device 8 that comprises a press 12 in the form of a continuous belt press for pressing at least one primary product layer 14, in the present case three primary product layers 14.1, 14.2, 14.3, to form a raw oriented strand board 16 as well as an oriented strand board production device 10. The at least one primary product layer 14 is created by a scattering device 18.

In the present case, the scattering device 18 comprises a first scatterer 20.1 for scattering a first primary product layer 14.1 in the form of a first surface chip layer, a second scatterer 20.2 for scattering a second primary product layer 14.2 in the form of a middle chip layer and a third scatterer 20.3 for scattering a third primary product layer 14.3 in the form of a second surface chip layer.

After being pressed by the press 12, the resulting raw oriented strand board 16 has a first surface layer 22.1, a middle layer 22.2 and a second surface layer 22.3. The press is heated, for example, by means of a thermofluid 24, which flows in heating pipes 26.j (j=1, . . . ). The heat of the thermofluid 24 is transferred to a circulating press belt 28, which presses onto the primary product layers 14.1, 14.2, 14.3 by means of pressure rollers 30.k (k=1, 2, . . . ). Of course, more or fewer than three primary product layers can be provided.

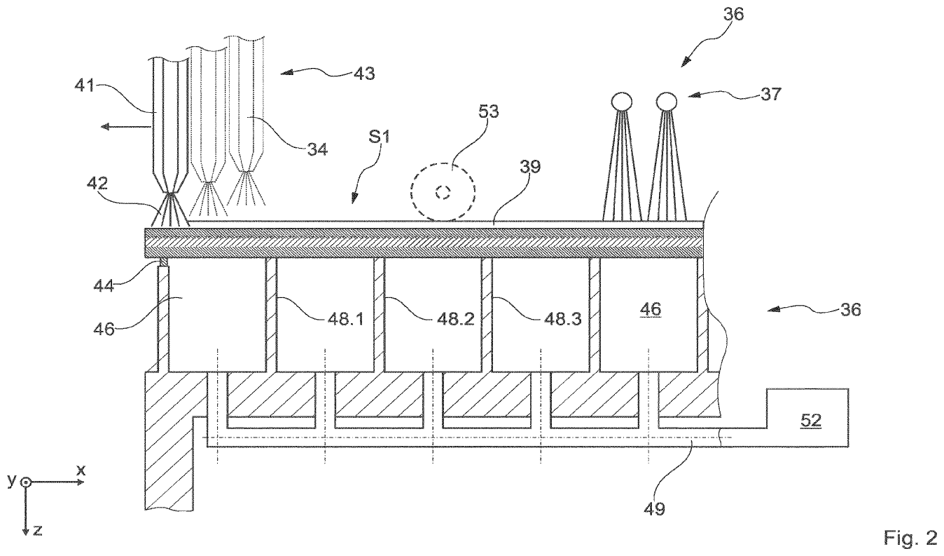

A liquid application device 32 is arranged downstream of the press 12 in a direction of material flow, by means of which a liquid 34 is applied to a first main surface S1 of the raw oriented strand board 16. The liquid application device 32 comprises a liquid reservoir 38 as well as a pump 40 by means of which the liquid 34 is guided to at least one nozzle 41 at a liquid pressure p₃₄. The nozzle 41 generates a spray 42 that settles on the first main surface S1. The nozzle 41 can be part of a nozzle bar 43 (see FIG. 2) that comprises 2, 3 or more nozzles. The liquid application device 32 can comprise a temperature control device 45, which keeps the liquid 34 at a given temperature T₃₄.

The liquid 34 is a suspension or emulsion and contains paraffin and/or wax as well as solid particles. An application quantity Q₃₄ of liquid 34 is Q₃₄=300 g/m². The paraffin and/or wax content in the liquid 34 is so great that it corresponds to a paraffin/wax application quantity of Q_{PW}=300 g/m². In the present case, the solid particles are made of corundum and have a particle size F 120 according to the FEPA standard.

The solid particle content in the liquid 34 is so great that it results in a solid particle application quantity of Q_{FP}=50 g/m².

A heating device 37 is arranged downstream of the liquid application device 32 in the direction of material flow M, the former comprising, for example, at least one infrared radiator 37a, 37b. A liquid layer 39 formed by the liquid on the raw oriented strand board 18 is dried by means of the heating device 37. In addition, the paraffin and/or the wax in the liquid layer 38 is heated until it melts. This leads to the formation of a thin paraffin/wax layer 39′.

By means of a suction device 36, which has a suction hood 47 and a circumferential seal 44, by means of which the second main surface S2 is sealed off from a suction chamber 46, a negative pressure is applied in the suction chamber 46 so that a pressure p₄₆ in the suction chamber 46 is less than p₄₆=500 hPa, in particular less than p₄₆=200 hPa. Due to the negative pressure, the liquid 34 is sucked into a first subsurface 50.1 of the raw oriented strand board 16.

The suction device 36 has supports 48.m (m=1, 2, . . . ) for reducing or preventing a deflection of the raw oriented strand board 16 due to the negative pressure.

FIG. 2 shows an enlarged view of the suction device 36. The suction chamber 46 is connected to a vacuum pump 52 by means of a vacuum line 49. As an alternative or in addition to the at least one nozzle 41, the liquid 34 can be applied to the first main surface S1 by means of an application roller 53 or another device.

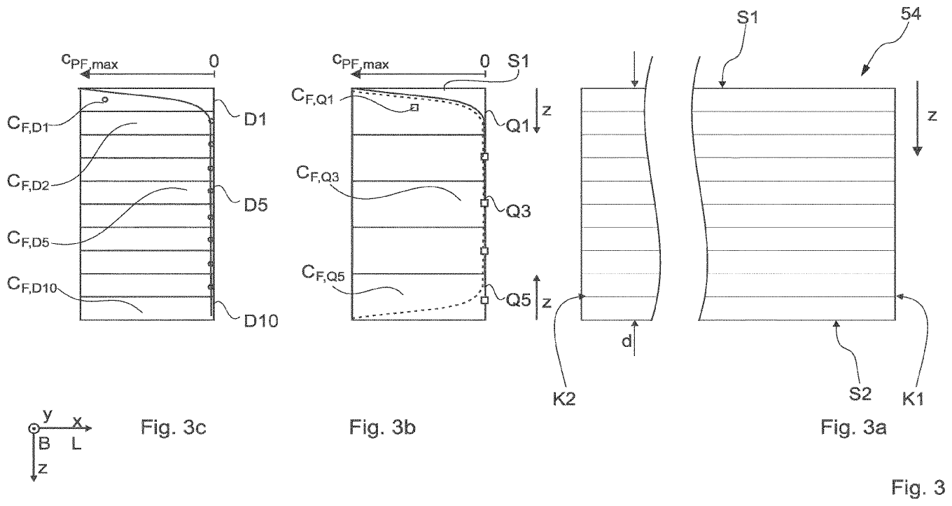

FIG. 3a schematically depicts a cross-section through an oriented strand board 54 according to the invention, which has a first edge surface K1 and a second edge surface K2.

FIG. 3b shows the course of the concentration c_{PW} of paraffin and/or wax in the oriented strand board 54 as a function of the distance z from the respective nearest main surface S1, S2. It can be seen that the concentration c_{PW,Q1} is significantly greater in the first, i.e. outermost quintile Q1, in particular by a factor of 10 or more than in an inner thickness quintile Q3, i.e. the quintile with the greatest distance to both main surfaces S1, S2. It is possible that, as shown in FIG. 3b, paraffin and/or wax is only applied to one side of the oriented strand board 54. If, as intended according to a preferred embodiment, the raw oriented strand board 16 is turned after the liquid 34 is applied and if the liquid 34 is applied to the opposite side, it results, for example, in the course of concentration CFP shown by the dashed line.

FIG. 3c depicts a division into deciles. It can be seen that a second decile concentration c_{PW,D2} of paraffin and/or wax in the second decile D2, which lies in the direction of a center of the thickness expansion next to the first, outermost thickness decile D1, can be less than one third of a first decile concentration c_{PW,D1}.

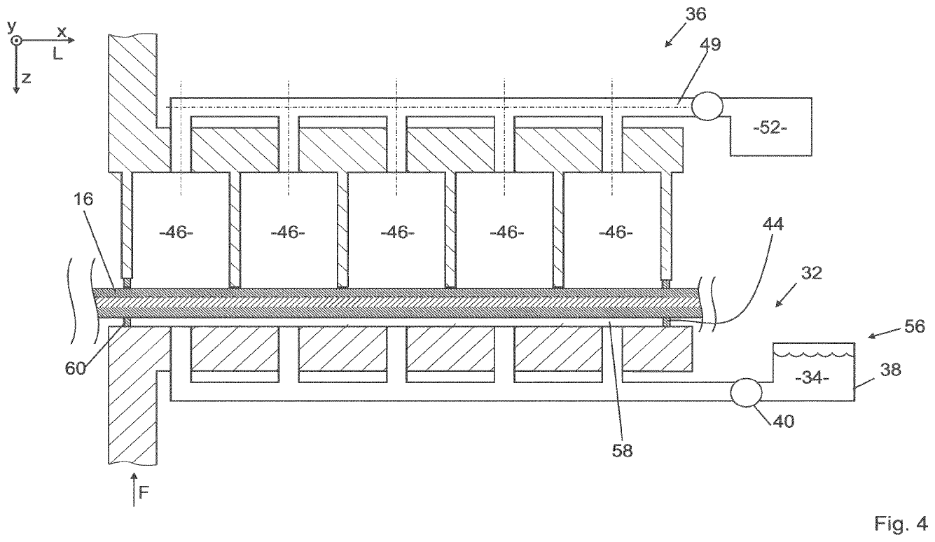

FIG. 4 shows a liquid application device 32 of an oriented strand board production device 10 according to the invention that comprises a pressure application device 56 which, by means of the pump 40, introduces liquid 34 from the liquid reservoir 38 into an introduction chamber 58 at an introduction pressure pe. The introduction chamber 58 is limited by a seal 60 of the pressure application device 56. The pressure application device 56 can be designed to apply the liquid 34 from below, as depicted in FIG. 4, or from above.

By means of the vacuum pump 52 of the suction device 36, a pressure of p₄₆=100 hPa, for example, is set in the suction chamber 46 via the vacuum line 49.

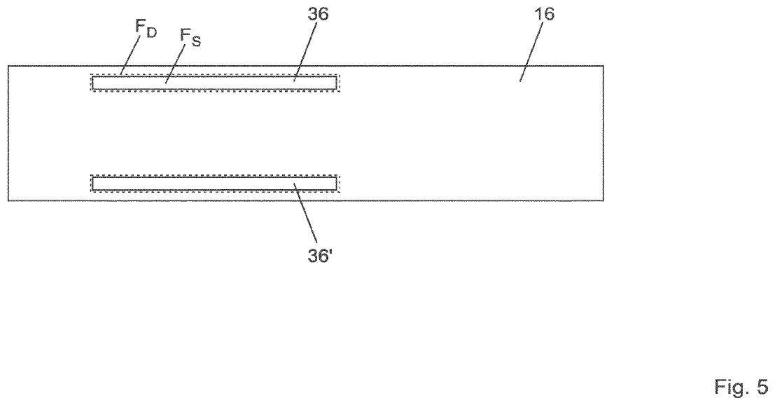

FIG. 5 schematically shows that the suction device 36 can be configured to apply a local negative pressure. In this case, a suction surface Fₛ is smaller than the surface of the raw oriented strand board 16. In the present case, the suction surface Fₛ is smaller than one tenth of the surface of the raw oriented strand board 16. The wood-based material panel production device may also comprise a second suction device 36′, which is preferably structurally identical to the first suction device 36.

A pressure surface F_{D}, to which the pressure application device 56 applies the introduction pressure pe, largely corresponds to the suction surface Fₛ, i.e. with a deviation of at most a factor of 2, for example, in particular at most a factor of 1.1, in particular at most a factor of 1.25.

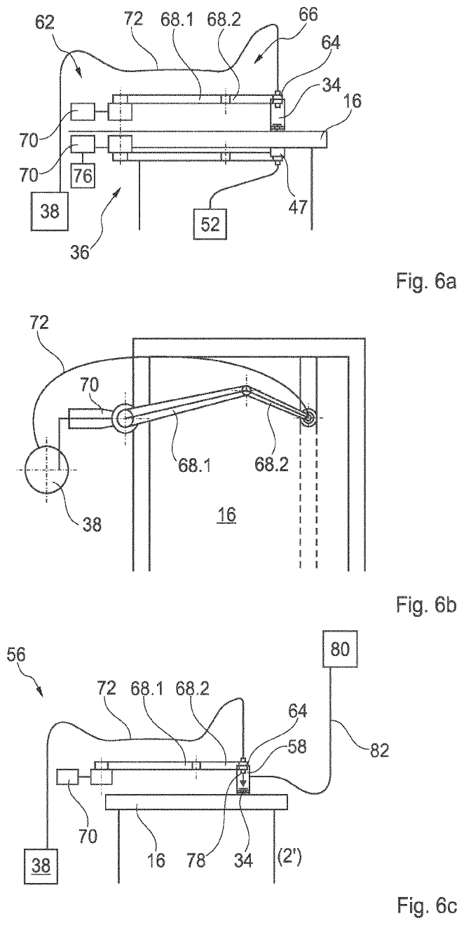

FIG. 6a shows a positioning device 62, such as a robot, for positioning an applicator 64 and for pressing the applicator 64 against the raw oriented strand board 16. For this purpose, the positioning device 62 has an arm 66, for example. The arm 66 may comprise 2 or more partial arms 68.1, 68.2, which can be connected to each other in an articulated manner. By means of a drive 70, the applicator 64 can be automatically positioned to a position relative to the raw oriented strand board 16, wherein said position can be preset.

The applicator 64 is supplied by means of a flexible line 72 with a pressurized liquid 34, which is sprayed onto the raw oriented strand board 16 and/or pressed into the raw oriented strand board 16 under pressure.

Irrespective of the features otherwise specified for the present embodiment, the wood-based material panel production device 10 can comprise a suction device 36, which has a suction hood 47 that can be positioned at a given point. The suction device 36 is designed in such a way that the suction hood 47 is always positioned opposite the applicator 64. To this end, the drive 70 is controlled by a control unit 76 of the wood-based material panel production device 10. The suction hood 47 is connected to the vacuum pump 52 by means of a flexible vacuum line.

FIG. 6c depicts a further embodiment of a pressure application device 56 in which the liquid containing flame retardant 34 is introduced into the introduction chamber 58 by means of a nozzle 78. The introduction pressure pe can be set by means of a pressure source 80, which is connected to the introduction chamber 58 via a pressure line 82.

It is possible to move the applicator 64 and, if necessary, the suction hood 47 while an overpressure and/or negative pressure is applied. Alternatively, the pressure in the suction chamber and/or the introduction pressure is approximated to the ambient pressure before the applicator and/or the suction hood is moved, in particular completely approximated.

The control unit 76 is used in all embodiments of the oriented strand board production device 10 in order to control the suction device 36 and/or the pressure application device 56 in such a way that a predetermined negative pressure is applied to the oriented strand board 16 for a predetermined suction time t_{saug} and/or a predetermined overpressure is applied for a predetermined overpressure time t_{druck}.

### Embodiment Example 1: Surface Sealing

With the aid of an application roller, a liquid 34 in the form of a paraffin emulsion/dispersion is applied in an application quantity of Q₃₄=100 g/m² to an unsanded oriented strand board with a thickness d of d=16 mm OSB. Pressure p₄₆₌₁₀₀ hPa is applied to the second main surface S2. The suction time is t_{saug}=30 sec. The emulsion is then drawn into the board to the extent that no more liquid can be seen. The board is dried and the wax melted with the aid of a heating device 37 in the form of an infrared radiator so that the wax spreads across the surface. Depending on the field of application, a soft paraffin, a micro-wax or a paraffin wax can be used.

The oriented strand board is tested after drying and cooling by means of a water application test. 5 ml of water was applied to the surface and covered with a watchglass. An untreated oriented strand board was tested at the same time. While the water was absorbed into the untreated oriented strand board after one hour, the water could be recovered from the treated OSB after two days.

A water vapor permeability test in accordance with DIN 53122-1 was also carried out. An outdoor climate of 90% relative humidity and 23 °C was selected. The flask on which the sample was placed contained phophorpene pentoxide as a desiccant. The values were 16 g/m²×d (paraffin coating) and 29 g/(m²×d) (reference sample). The water vapor permeability could therefore be almost halved with this coating. The permeability of water can be controlled by varying the amount of paraffin applied.

### Embodiment Example 2: Surface Sealing with Anti-Slip Properties

A mixture of paraffin emulsion/dispersion and corundum in two grain sizes, namely F 120 and F 80 according to the FEPA standard, is applied to an unsanded 16 mm oriented strand board using an application roller. The paraffin/wax application quantity is Q_{PW}=100 g, the solid particle application quantity is Q_{FP}=50 g corundum per square meter. The solids content of the emulsion/dispersion is 50 percent by weight. A pressure of p₄₆=100 mbar is applied, the suction time is t_{saug}=30 sec. The emulsion/dispersion is then drawn into the board to the extent that no more liquid can be seen.

The board is dried and the wax melted with the aid of a heating device 37 in the form of an infrared radiator so that the wax spreads more effectively across the surface and ensures effective absorption of the solid particles into the paraffin film. Depending on the field of application, a soft paraffin, a micro-wax or a paraffin wax can be used. A second oriented strand board is equipped with the same quantity of glass beads instead of corundum. Their grain size is between 70 and 110 μm.

Another oriented strand board was produced without hard particles using only paraffin. An oriented strand board without surface treatment was also tested. The slip resistance of all oriented strand boards was then determined using a small metal block (500 g). The metal block was placed at one end of a 40 cm long and 10 cm wide test specimen and then the oriented strand board was slowly moved upwards at this end. The angle of inclination at which the metal piece starts to slip is the measure of slip resistance. This was tested in both dry and wet conditions. For the wet measurement, 100 g of water per square meter was applied.

The following table shows that the oriented strand boards treated with paraffin and corundum have clear advantages in terms of slip resistance compared to the zero sample and the oriented strand board treated with glass beads.

TABLE 1
Anti-slip

| | | | | | Emulsion | Emulsion | Emulsion |
|---|---|---|---|---|---|---|---|
| | | | | | (50 g | (50 g | (50 g |
| | | | | Emulsion | paraffin | solid/m²) + | solid/m²) + |
| | | | | 50 g | solid/m²) + | corundum (F | corundum (F |
| Height | Angle | | reference | paraffin | glass | 120, FEPA | 80, FEPA |
| [cm] | [°] | dry/wet | sample | solid/m² | (70-100 μm) | standard) | standard) |
| 13 | 15 | dry | + | + | + | + | + |
| | | wet | + | + | + | + | + |
| 15 | 17 | dry | − | + | + | + | + |
| | | wet | + | + | − | + | + |
| 17 | 20 | dry | − | − | − | + | + |
| | | wet | + | + | − | + | + |
| 19 | 23 | dry | − | − | − | + | + |
| | | wet | + | − | − | + | + |
| 20 | 24 | dry | − | − | − | + | + |
| | | wet | − | − | − | − | + |
| 22 | 27 | dry | − | − | − | − | + |
| | | wet | − | − | − | − | + |

1. A method for producing an oriented strand board, comprising:
(a) treating or producing a raw oriented strand board that comprises a first main surface, a second main surface that extends parallel to the first main surface, and edge surfaces that connect the main surfaces to each other,
(b) applying a liquid, which contains paraffin and/or wax, to at least the first main surface,
(c) applying a negative pressure to the second main surface so that the liquid is sucked into a subsurface of the raw oriented strand board and/or applying an overpressure to the first main surface so that the liquid is pressed into a subsurface of the raw oriented strand board, and
(d) heating the first main surface so that the paraffin and/or the wax melts, resulting in the oriented strand board.

2. The method according to claim Error! Reference source not found., wherein the liquid is applied in such an application quantity that the oriented strand board has an oriented strand board water vapor permeability of the oriented strand board that is at least 30% lower than a raw oriented strand board water vapor permeability of the raw oriented strand board.

3. The method according to claim 1, wherein the liquid contains solid particles.

4. The method according to claim 1, wherein the liquid contains elemental carbon.

5. The method according to claim 3, wherein
a concentration of elemental carbon in the liquid and an application quantity are selected in such a way that an oriented strand board reflectivity of the oriented strand board in a direction of a normal to the oriented strand board at 23 °C under IR light with a wavelength of 700 nm is at least 0.05 less than a raw oriented strand board reflectivity of the raw oriented strand board.

6. The method according to claim 1, wherein the liquid contains a salt and a concentration of the at least one salt in the liquid and an application quantity of the liquid to the raw oriented strand board are selected such that an electrical oriented strand board conductivity of the oriented strand board is at least 50% greater than an electrical raw oriented strand board conductivity of the raw oriented strand board.

7. The method according to claim 1, wherein the liquid contains a dye.

8. The method according to claim 1, wherein
(a) the liquid is applied by nozzles and/or rollers, and/or
(b) the liquid is applied to the main surface from below, wherein the liquid is in contact with the main surface with its at least essentially horizontal liquid surface during application.

9. The method according to claim 1, wherein the negative pressure is applied from above, and
wherein the negative pressure is applied by a suction hood to a suction surface, which corresponds to a pressure surface where the liquid is injected.

10. The method according to claim 1, wherein
(a) an applicator is moved relative to the raw oriented strand board while the liquid is being injected, and/or
(b) the raw oriented strand board is moved and the applicator is moved with it.

11. The method according to claim 1, wherein a concentration of the paraffin and/or wax and the application quantity are selected in such a way and the negative pressure and a suction time are selected in such a way that an inner concentration of the paraffin and/or wax in an inner thickness quintile of a thickness expansion from the first main surface to the second main surface is at most 0.8 times an outer concentration in a first outermost thickness quintile that extends to the first main surface.

12. An oriented strand board coating device comprising
(a) a liquid application device for applying a liquid to a raw oriented strand board,
(b) a liquid source that is connected to the liquid application device and contains the liquid,
(c) a suction device configured to apply a negative pressure to a second main surface of the raw oriented strand board and to automatically apply a negative pressure for such a suction time that the liquid is sucked into a subsurface of the raw oriented strand board and/or
a pressure application device for applying an overpressure to the first main surface so that the liquid is pressed into a subsurface of the raw oriented strand board,
(d) the liquid contains paraffin and/or wax, and
(e) the oriented strand panel production device comprises a heating device arranged downstream of the liquid application device in a direction of material flow, the heating device being configured and arranged to automatically heat a first main surface, which lies opposite the second main surface, to a temperature at which the paraffin and/or the wax melts and does not decompose.

13. The oriented strand board coating device according to claim 0, wherein
(a) the suction device is designed to automatically apply the negative pressure for such a suction time that the liquid is not sucked through the raw oriented strand board, and/or
(b) the pressure application device is configured to automatically apply the overpressure for such an overpressure time that the liquid is not pressed through the raw oriented strand board.

14. An oriented strand board, comprising:
(a) an inner concentration of paraffin and/or wax in an inner thickness quintile of a thickness expansion from a first main surface to a second main surface is at most 0.5 times an outer concentration in a first outermost thickness quintile that extends to the first main surface, and/or
(b) a second-decile concentration of the paraffin and/or wax in the second thickness decile of the thickness expansion, which lies next to a first outermost thickness decile in a direction of a center of the thickness expansion, is at least 0.1 times a first-decile concentration in the first outermost thickness decile.

15. The oriented strand board according to claim 14, wherein an oriented strand board surface of the oriented strand board contains
(a) elemental carbon on at least 50% of its area, and/or
(b) at least 30 g per square meter of hard material particles which have a grain size of between 70 and 150 μm.
